(19) United States
(12) Patent Application Publication
(10) Pub. No.: US 2003/0136071 A1
(43) Pub. Date: Jul. 24, 2003

(54) Reinforced concrete slab

(76) Inventor: Herbert S. Kobayashi, Webster, TX (US)

Correspondence Address: Marvin J. Marnock, 13630 Indian Creek Rd., Houston, TX, 77079, US

(21) Appl. No.: 10/052,616

(22) Filed: Jan. 23, 2002

(51) Int. Cl. E04B 1/18; E04B 2/00; E06B 3/54; E04B 9/00; E04H 12/00

(52) U.S. Cl. 52/414; 52/432; 52/582.1; 52/649.1

(57) ABSTRACT

A reinforced concrete slab 10 comprising concrete 11 reinforced by parallel, spaced planar truss members 12 fabricated of rebar rod materials, each comprising a sinusoidal wave-like strut 23 with an upper chord member 21 welded thereto at the maxima apexes 24 thereof and a lower chord member 22 welded thereto at the minima apexes 25 thereof, a plurality of spaced rebar braces 14 extending the width of the slab and welded to the truss members 12 in perpendicular relation thereto, a plurality of plastic pipes 16 extending through the concrete 11, each with its ends opening at the edges of the slab 10 for reducing its weight and/or accommodating utilitarian articles, such as electrical wiring and the like therethrough, and a plurality of steel adapters 30A, 30B fixed at the edges of the slab by welding to the rebar components thereof and serving to facilitate lifting of the slab when necessary and for connecting the slab to other slabs or structures.

### FIELD OF THE INVENTION

The invention relates to a concrete slab and the construction thereof, and more particularly to a reinforced concrete slab constructed with internal truss-like rebar members and rebar braces and which can be used in many applications, as for example, as a pallet, as part of a building wall or roof, and in bridges and in highways.

### BACKGROUND OF THE INVENTION

In the prior art, steel rebar members are often used to reinforce concrete slab constructions and are typically of linear configuration and placed in the center of the slab. Such slabs do not stand up well and tend to crack and fracture when placed in tension or compression as when the slab is supported solely at its respective ends. Other slabs may use truss-like members, but these are generally inadequately spaved and braced, cannot be readily attached to other structural members or lifted without chipping, cracking or fracturing the slab.

### SUMMARY OF THE INVENTION

The present invention is a concrete slab which is reinforced by a plurality of rebar members in the form of trusses and braces. Each of the truss members is provided with an upper chord member and a lower chord member which are joined by a central rebar truss member having a serrate or sunusoidal configuration which is joined at its upper and lower apexes to the upper and lower chord members in planar relation therewith by welding. In a slab in accord with the invention, a plurality of such truss members are placed in spaced pararallel relation to one another as the concrete is poued thereabout to form a rectangular form of slab. The truss members are also joined by a plurality of linear braces, which are also steel rebar members, arranged and welded thereto in spaced parallel relation to one another and in perpendicular transverse relation to the truss members. The slabis also provided with a plurality of plastic pipes which extend therethrough from end to end adjacent to the truss members and which serve to lighten the overall weight of the slab without reducing its strength and to also serve to provide passages for running electrical wiring and other utilitarian items and the like therethrough. Such plastic pipes may also be provided to run transversely of the slab from one side of the slab to the other or from one end of the slab to a side of the slab. The plastic pipes can also serve to accommodate connecting members therethrough for connecting the slabs to one another or to other structural members.

In addition, lift and connect steel adapters are provided at each edge of the slab by welding each adapter to a truss member or a brace. The adapters are fixed at the edge of the slab in sufficient number and in appropriate spaced relation to one another so as to provide lift points at which lifting devices may be applied when the slab is to be lifted or moved to thereby minimize the possibility of fracturing or cracking the slab. When it is desired to connect one slab to another in side-by-side relation or to another structural component in a building structure, the adapters may be secured to one another or to the structural component by welding or by bolts through accommodating bolt holes or threaded openings provided in the adapters.

### BRIEF DESCRIPTION OF THE DRAWINGS

FIG. 1 is a top plan view of a concrete slab of the invention wherein a portion of the slab has been omitted for purposes of illustrating the arrangement of reinforcing rebar rods and plastic tubing members included in its construction;

FIG. 2 is a section view of the slab of the invention as taken along the section line 2-2 in FIG. 1;

FIG. 3 is an enlarged side edge view of a portion of the slab illustrated in FIG. 2;

FIG. 4 is a section view as taken along the section line 4-4 in FIG. 1 and showing components of the slab of the invention;

FIG. 5 is an enlarged fragmentary view of the portion of the slab shown in FIG. 4;

FIG. 6A is a perspective view of a portion of one of the reinforcing truss members included in the slab of the invention;

FIG. 6B is a perspective view showing a plurality of reinforcing members as shown in FIG. 6A which are joined together in spaced relationship as major components of the slab of the invention;

FIG. 7 is a fragmentary side view of the fragment of truss member shown in FIG. 6;

FIG. 8 is an end section view of the truss member of the slab as taken along the section line 8-8 in FIG. 7;

FIG. 9A is a perspective view of one of the steel adapters which are attached at the side edges of the slab by welding to a rebar member;

FIG. 9B is a perspective view of longer modified form of the steel adapter of FIG. 9A;

FIG. 10 is a top plan view of the steel adapter shown in FIG. 9;

FIG. 11 is a side view of the slab adapter shown in FIG. 9A;

FIG. 12 is a bottom plan view of the adapter shown in FIG. 9A;

FIG. 13 is a frontal view of the adapter shown in FIG. 9A;

FIG. 14 is a schematic perspective view showing an arrangement of slabs of the invention which are joined along their side edges to form a wall;

FIG. 15 is a perspective view showing two walls joined in right angular relationship, each wall formed by a number of slabs of the invention;

FIG. 16 is a perspective view showing the walls of a building structure wherein each of the walls is formed by a wall constructed from slabs of the invention.

### DETAILED DESCRIPTION OF THE INVENTION

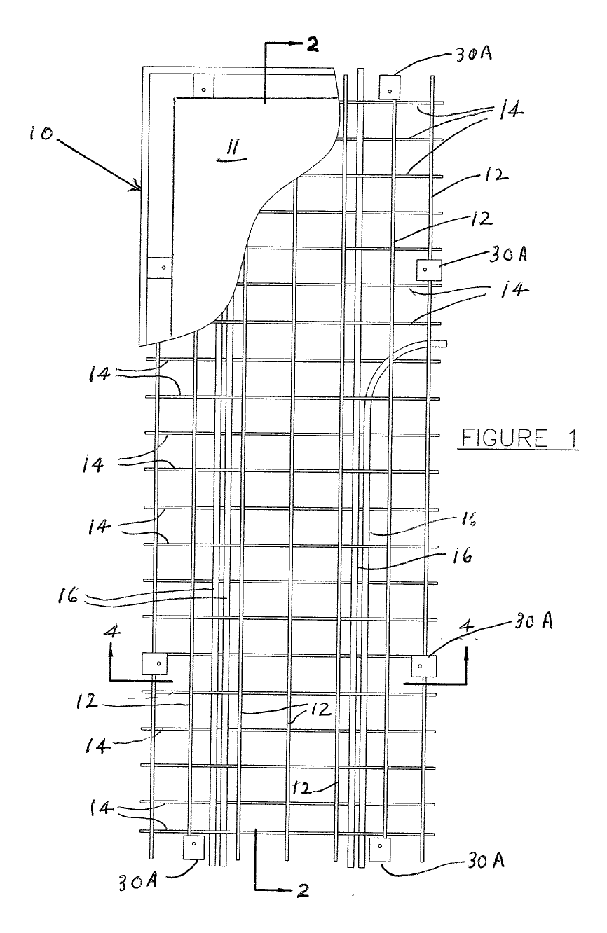

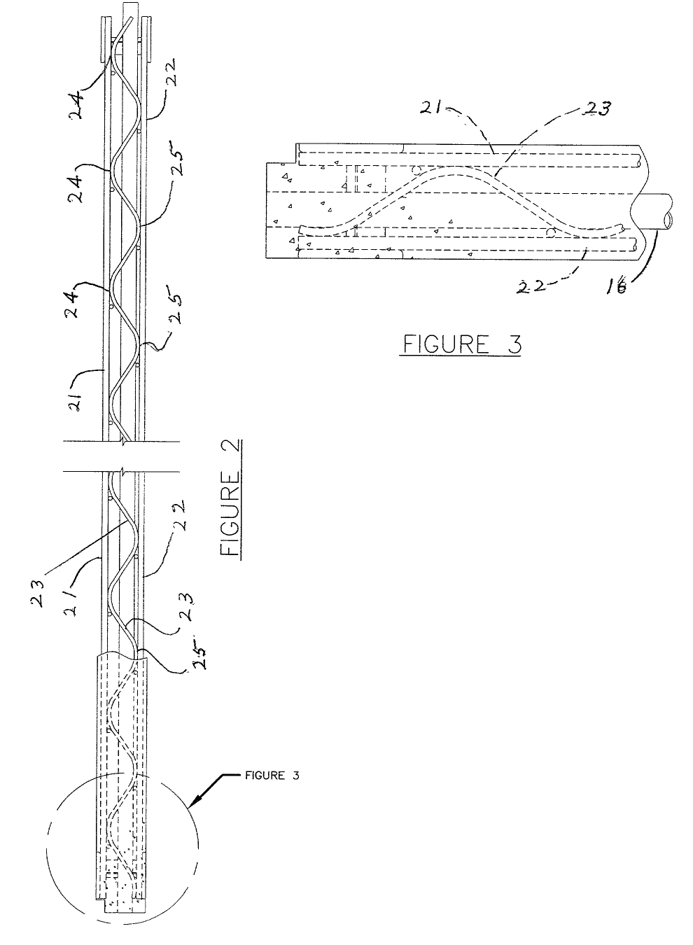

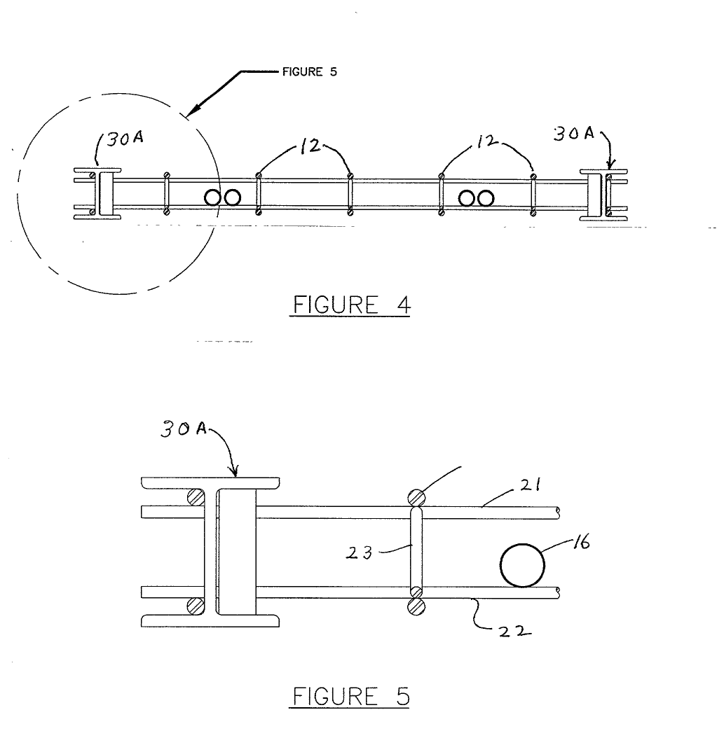

Referring more particularly to the drawings, there is shown in FIG. 1 a top plan view of a slab 10 of the invention wherein a portion of the concrete 11 has been omitted to illustrate the arrangement of reinforcing truss members 12, braces 14 and plastictic tubing members 16 which are included in its construction. The slab 10 is preferably of rectangular configuration and forms a rectangular block.

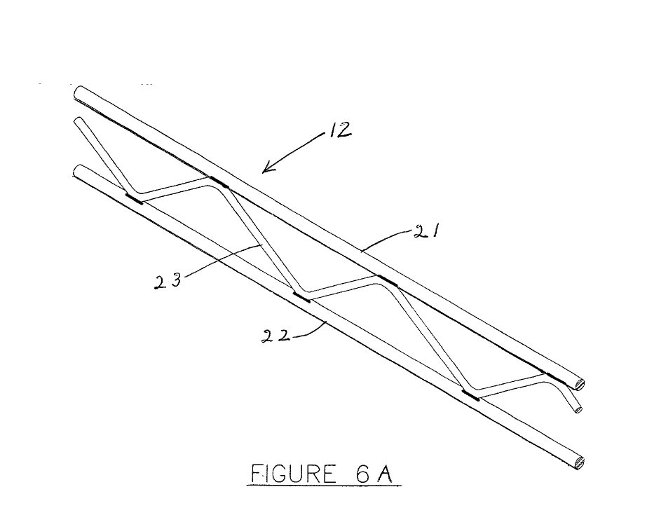

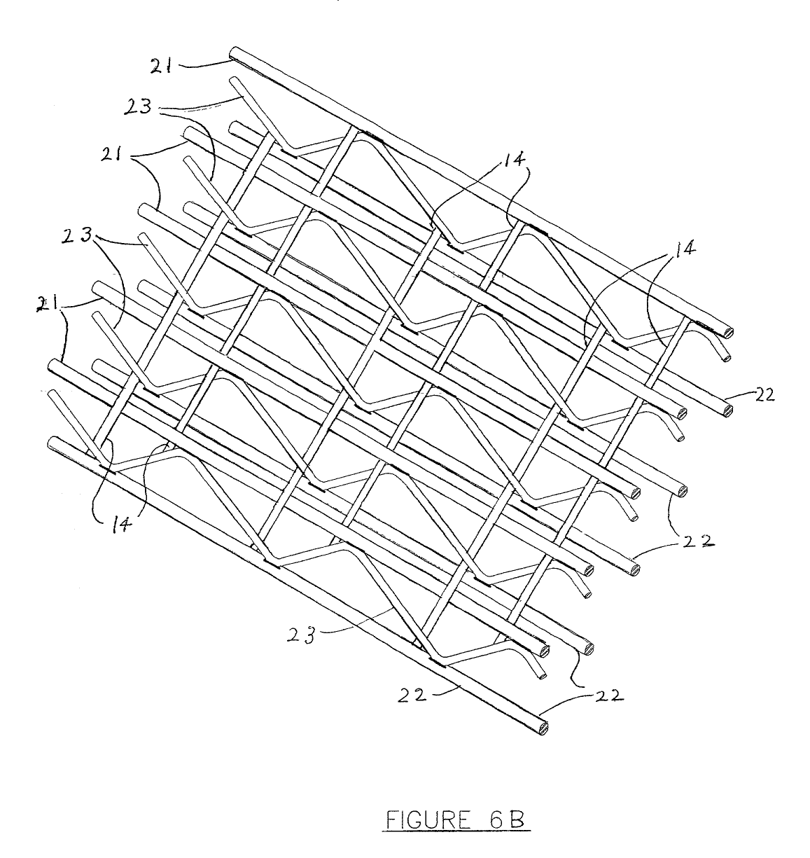

A truss member 12, as shown in FIG. 2 in a section view of the slab 10 and in perspective in FIG. 6A is one of several truss members about which the wet concrete is poured during construction. Each truss member is constructed of upper and lower steel chord members 21, 22, both of which are welded to a steel strut 23 of sinusoidal wave-like configuration with the upper chord member 21 welded to the strut 23 at the upper maxima apexes thereof and the lower chord member 22 welded to the strut 23 at the lower minima apexes thereof.

As seen in FIGS. 1 and 6B, the truss members 12 are arranged in parallel spaced relationship to one another and are joined and braced by the plurality of the elongate rebar members 14, each of which is connected by welding to at least two of the truss members 12 in perpendicular relation thereto. The braces 14 are in spaced parallel relation to one another, substantially uniform, and each extends for substantially the width of the slab from one side edge of the slab to the other.

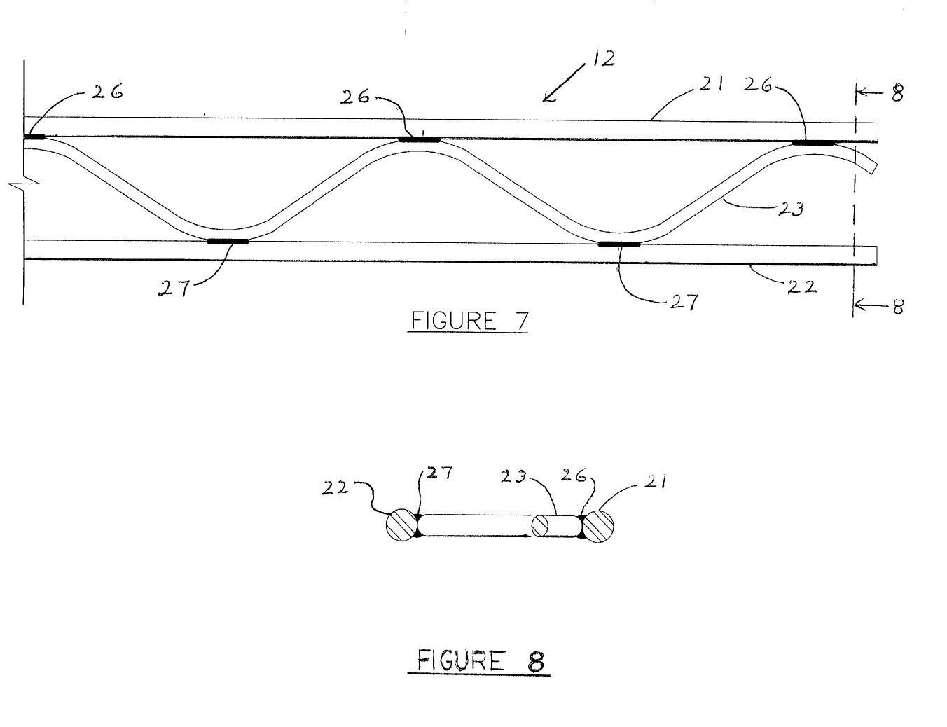

An enlarged detailed fragmentary view of a truss member 12 as illustrated in FIG. 7 shows the weld connections 26 of the steel strut 23 to the upper steel chord member 21 and the weld commection of the strut 23 to the lower steel chord member 22. A section view of the truss member 12 adjacent one end thereof and showing the welds 26, 27 is shown in FIG. 8.

For a particular application of the slab 10 of the invention, the anticipated stresses on the slab can be determined by mathematical analysis, the number of trusses, braces and plastic pipes and their strength and relative spacing can be selected accordingly.

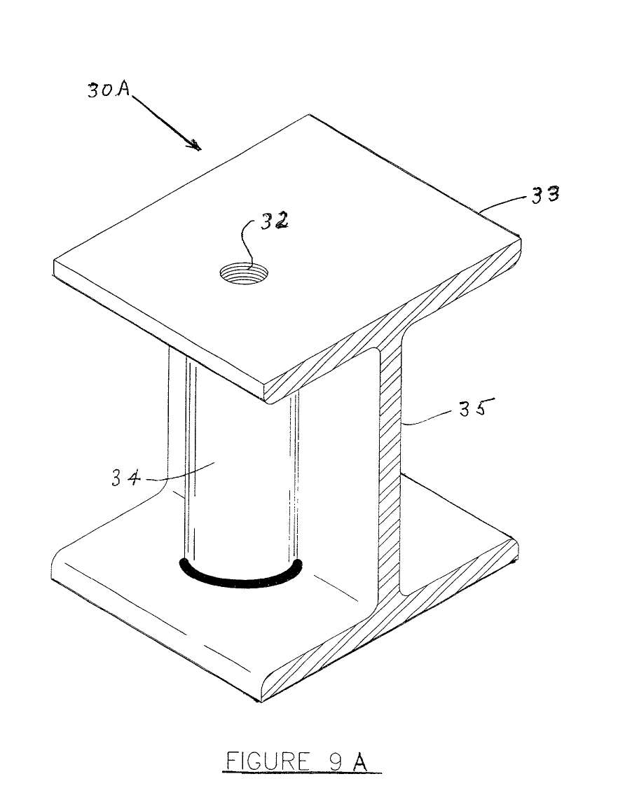

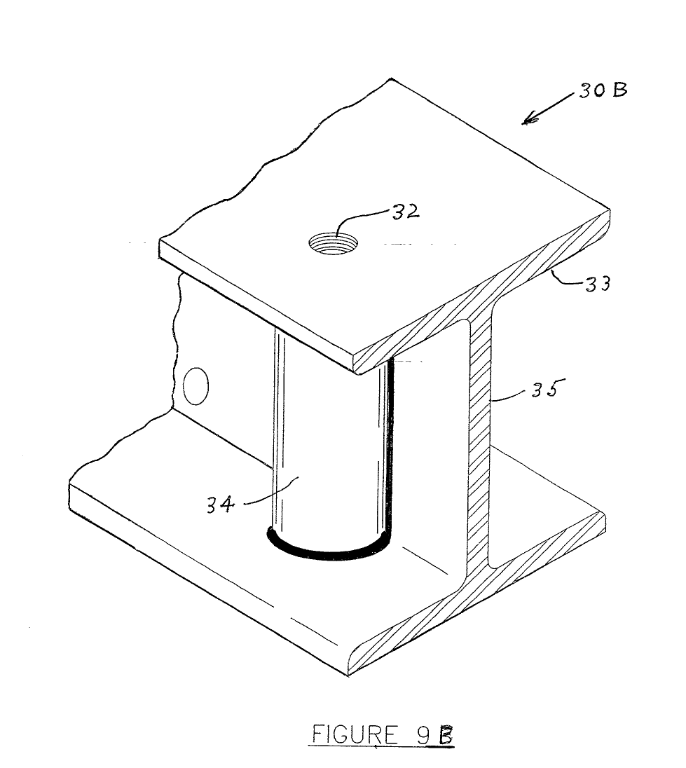

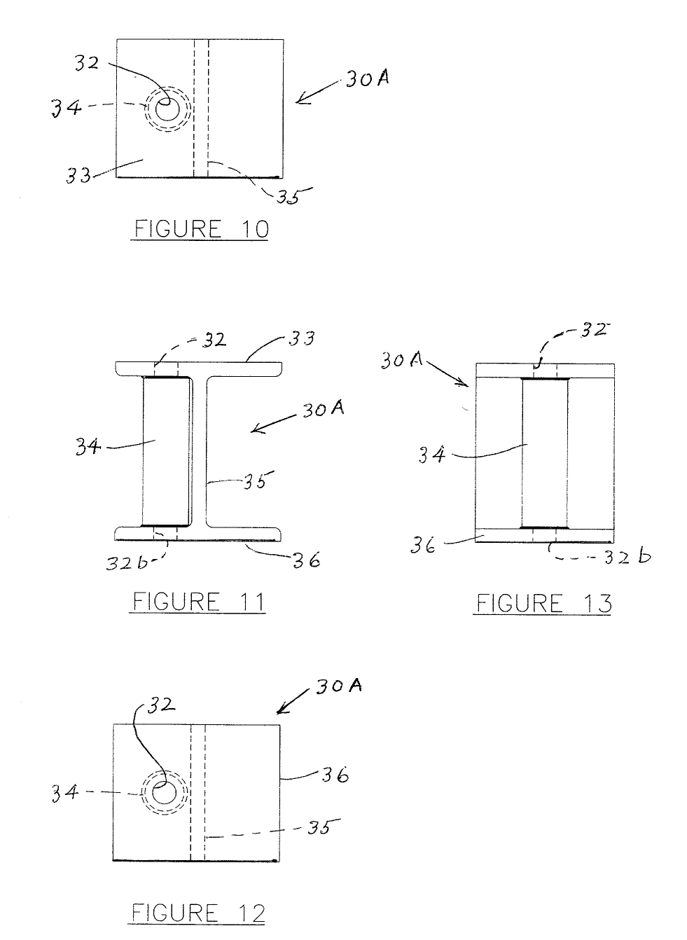

It is also to be appreciated that the moving of a concrete slab when it becomes necessary, has heretofore been a difficult task, sometimes resulting in cracking or fracture of the slab. To facilitate the lifting and moving of the slab 10 of the present invention, it is provided with a plurality of steel adapters 30A and 30B as shown in enlar views in FIGS. 9A and 9B. Other views of the adapter 30A are shown in FIGS. 10-13, respectively. The adapter 30B shown in FIG. 9B is a modified lengthened form of the adapter 30A. Each steel adapter 30A, 30B is attached at the side edge of the slab 10 by welding to one of the steel rebar components of the slab 10. It may be attached to the end of a truss member 12 at the top edge of the slab 10 or to the truss member at locations intermediate its ends such as shown on the right side of the slab 10 in FIG. 1. It might also be welded to the end of a brace 14. The adapter locations are selected at appropriate spaced intervals on the slab edge to provide multiple lift points whereby the slab may be lifted without placing undue stress on the slab.

It is seen in FIG. 9A, 9B that the adapters 30A, 30B, are of an “I” configuration in transverse cross section and that the adapter is provided witha threaded opening 32a in its upper transverse section 33 and a hollow cylinder portion 34 in coaxial alignment therewith and located adjacent the vertical section 35 of the adapter in parallel relation thereto. Another opening 32b is provided in the lower transverse section 36, also in alignment coaxially with the cylinder 34. The adapter 30B differs from adapter 30A principally in its length which may extend for the length of the slab. Its vertical section 35 is also provided with openings 37 which extend transversely therethrough and each being spaced and sized to accommodate the end of a brace 14 or a plastic pipe 16.

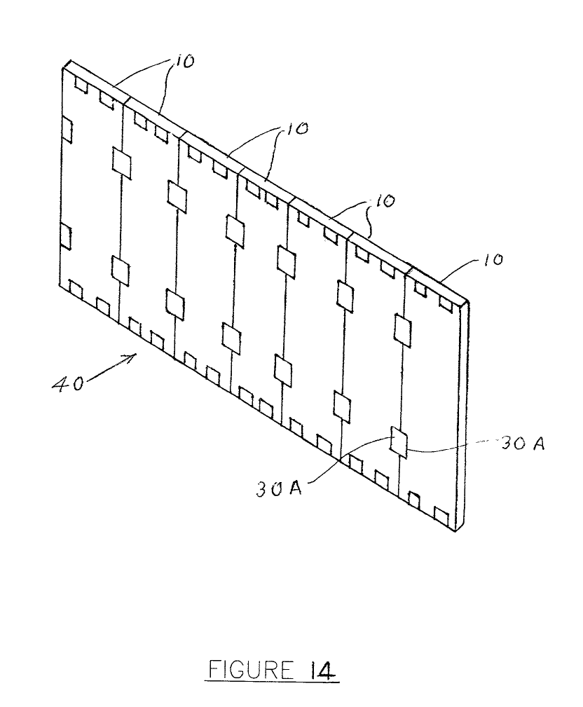

In FIG. 14, there is shown a wall 40 which is formed from a plurality of slabs 10 arranged with their planar upper and lower surfaces in co-planar relationship. Each slab 10 is joined edge-to-edge with an adjacent slab 10 by welding connection of the steel adapters 30A of one slab to the steel adapters 30A of the adjacent slab.

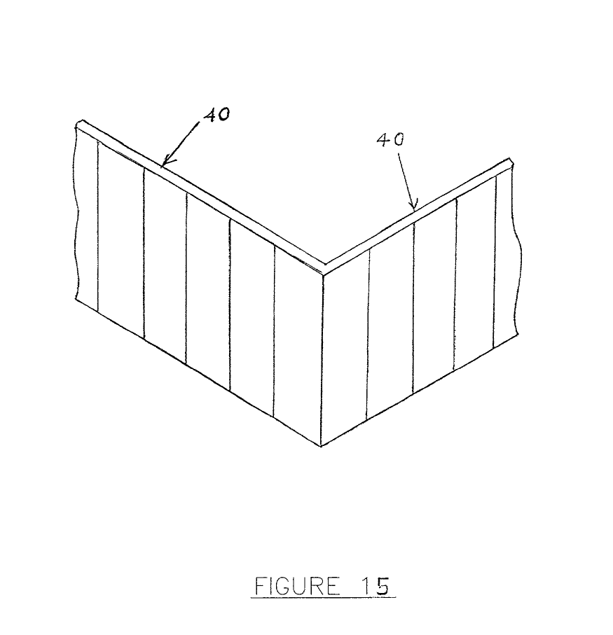

In FIG. 15, two such walls 40, formed as shown in FIG. 14 are joined to form a right angle connection with one another. Such walls might be provided with adapters 30B which extend the length of the slab and are welded to the adapters 30B of the adjacent slab throughout their length. However, bolted connections might also be provided by a bolt through their respective openings 32a, 32b.

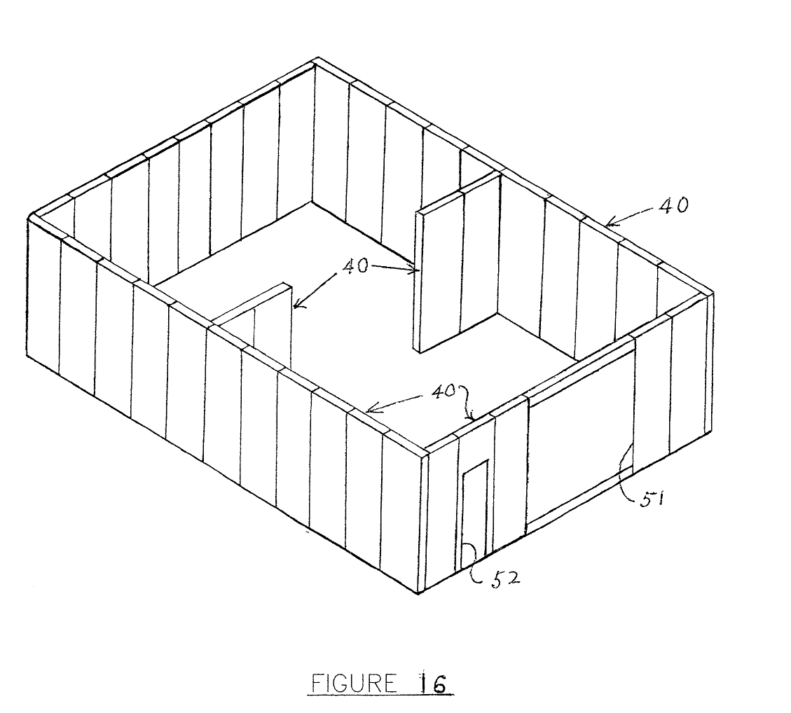

FIG. 16 shows a number of slab walls 40 connected to one another to form the framework of a house. A window 51 and door 52 can also be provided by modification of the slabs 10 in their configuration as may be necessary.

It is also to be appreciated that while the slab of the invention has heretofore been described as being of rectangular configuration, it might also be constructed in other geometric configurations such as square, polygonal and the like. It is to be understood therefore that the foregoing description of a preferred embodiment of the invention has been presented for purposes of explanation and illustration and is not intended to limit the invention to the precise forms disclosed. Accordingly, it is to be understood that various changes in materials and structure may be made without departing from the spirit of the invention.

1. A concrete slab reinforced by a plurality of plane trusses arranged in parallel spaced relation and about which wet concrete is poured during the slab construction, each of which plane trusses is constructed of an upper and lower steel chord member both of which are welded to a steel strut of sinusoidal wave-like configuration with the upper chord member welded to the strut member at the upper maxima apices thereof and the lower chord member welded to the strut member at the lower minima apices thereof,
a first plurality of elongate linear rebar brace members arranged in parallel spaced relation to one another and each of which is connected at ita ends to at least two of the spaced truss members in substantially perpendicular relation thereto.

2. A reinforced concrete slab as set forth in claim 1 and further comprising a plurality of tubular plastic pipe members, each of which extends through the concrete of the slab structure with its ends opening at the edges of the slab structure and thereby serves to lighten the total weight of the slab and also provides a passageway through the slab for accommodating items having utilitarian purposes.

3. A reinforced concrete slab as set forth in claim 2 and further comprising a plurality of steel adapter members arranged and fixed to the edge of the slab in spaced relation to one another to facilitate lifting of the slab when necessary and for connecting the slab to other structural components when used in a construction, and each of which is fixed to the slab at the edge thereof by a welding connection to a rebar component of the slab.

4. A reinforced concrete slab as set forth in claim 3 wherein each said adapter member is provided with an upper planar surface and a lower planar surface and is fixed to the edge of the slab with its upper planar surface substantially coplanar with the upper surface of the slab and with its lower planar surface substantially coplanar with the lower surface of the slab.

5. A reinforced concrete slab as set forth in claim 4 wherein each said adapter member is further provided with an opening in at least one of its upper and planar surfaces for facilitating reception therein of a connecting member of a structure to which the slab is adapted to be connected.

6. A reinforced concrete slab as set forth in claim 1 wherein said slab is of rectangular configuration and comprises a plurality of steel adapters arranged and fixed to the edge of the slab in spaced relation to one another to provide means for lifting the slab when necessary and for connecting the slab to other structural components when used in construction.

7. A plurality of reinforced concrete slabs as set forth in claim 6 wherein each of said slabs is joined along an edge thereof to another of said slabs to form a wall.

8. A plurality of reinforced concrete slabs as set forth in claim 6 wherein each of said slabs is joined along a side edge thereof to another of said walls to form a plurality of walls and said walls are joined to one another to form walls for the rooms of a building structure.
